(19) United States
(12) Patent Application Publication
(10) Pub. No.: US 2018/0181485 A1
(43) Pub. Date: Jun. 28, 2018

(54) SOURCE CODE EQUIVALENCE VERIFICATION DEVICE AND SOURCE CODE EQUIVALENCE VERIFICATION METHOD

(71) Applicant: Hitachi, Ltd., Tokyo (JP)

(72) Inventors: Daisuke SIMBARA, Tokyo (JP); Yasufumi SUZUKI, Tokyo (JP); Thi Thanh Huyen PHAN, Tokyo (JP); Shinya SAKAIDA, Tokyo (JP)

(21) Appl. No.: 15/561,207

(22) PCT Filed: Apr. 28, 2015
(86) PCT No.: PCT/JP2015/062852

§ 371 Date: Sep. 25, 2017

(51) Int. Cl. G06F 11/36; G06F 8/52

(52) U.S. Cl. CPC G06F 11/3688; G06F 8/52

(57) ABSTRACT

A source code equivalence verification device performs symbolic execution on both an original source code and a modified version of the original source code; generates, using the results of the symbolic execution, equivalence verification expressions for verifying equivalence between the original source code and the modified source code; and verifies the equivalence verification expressions. A correction candidate generation unit generates a correction candidate, on the basis of which the modified source code is to be corrected so as to be equivalent to the original source code, if the results of the verification of the equivalence verification expressions indicate that the modified source code is not equivalent to the original source code; and a verification result generation unit generates a verification result report using the results of the verification and the correction candidate generated by the correction candidate generation unit.

### TECHNICAL FIELD

The present invention relates to a device and a verification method, which verify that a behavior between source codes is equivalent at the time of modifying the source code, and support a developer to correct the behavior to be equivalent in a case where the behavior is not equivalent.

### BACKGROUND ART

There is a technology described in Patent Document 1 as a method for verifying the equivalence of a source code. In Patent Document 1, a method is disclosed in which a test is performed with respect to a portion in which a difference occurs due to source code comparison, and results thereof are compared with each other.

In addition, in Non-Patent Document 1, a method is disclosed in which it is verified that a behavior is retained by using symbolic execution.

### CITATION LIST

### Patent Document

Patent Document 1: US 2007/0033576 A1

### Non-Patent Document

Non-Patent Document 1: S. Person, M. B. Dwyer, S. Elbaum, C. S. Pasareanu, “Differential Symbolic Execution”, Proc. of ACM SIGSOFT Symposium on the Foundations of Software Engineering 2008, USA, 2008

### SUMMARY OF INVENTION

### Technical Problem

Recently, a software system has been prevalent in a general public as an information processing society progresses, and thus, reliability required for software has extremely increased. On the other hand, the software has been complicated and enlarged according to a differential and derivative development over a long period of time, a decrease of maintainability such as extensibility or understandability of the software becomes a problem.

There is refactoring or language replacement as a method of improving the maintainability of the software. The refactoring is a general term of a method in which an internal structure is modified without changing the behavior of the software, and thus, design quality of the software is improved. The language replacement is a method in which with respect to software developed by using a programming language having low maintainability, the same function as that of the software is recreated by using another programming language having high maintainability.

The method of the refactoring or the language replacement is a promising technology for ensuring the maintainability of the software which has been complicated and enlarged. However, when a source code of the software is modified or recreated, in the case of changing the behavior of the source code, which is a target, there is a possibility that a new trouble may occur. For this reason, a software developer may be afraid that a problem occurs in the software which has been properly operated, due to the refactoring or the language replacement, and thus, may intend not to perform the refactoring or the language replacement. In a maintenance stage of the software, in order to actively perform the refactoring or the language replacement, a method of verifying that there is no change in the behaviors of both of the source codes before and after the modification of the source code is required.

Herein, external behaviors of two source codes are the same, that is, obtaining the same output with respect to the same arbitrary input at the time of execution is defined as both of the source codes being “equivalent”. In addition, verifying whether or not the source codes before and after the modification are equivalent to each other is referred to as “equivalence verification”.

There are the following conditions as a condition required for a method of verifying that the source codes before and after the modification are equivalent to each other.

(1) One of the conditions is a condition in which most of an operation is automated, and thus, an operation using the manpower decreases. In the related art, the equivalence of the source code is verified by a review or a test using the manpower. Automatic verification using a tool is realized, and thus, the verification man-hour is reduced, and the refactoring or the like is accelerated.

(2) The other condition is a condition in which when it is determined that the source codes are not equivalent to each other by an equivalence verification method, information which is the basis of the determination or information relevant to a portion to be corrected or a correction method is provided to the developer. The information of the portion to be corrected is provided to the developer in an easy-to-understand manner, and the information relevant to the correction method is further provided, and thus, the developer easily performs the correction, and a development period or the man-hour is reduced.

In the method according to Patent Document 1, the test is required, and thus, the condition of (1) is not able to be satisfied. In addition, in the method according to Non-Patent Document 1, a logical expression for verifying the equivalence is generated, and the verification is performed by using a solver, but the information relevant to the portion to be corrected or the correction method is not provided, and thus, the condition of (2) is not able to be satisfied.

Therefore, an object of the present invention is to provide a technology for proposing information relevant to correction on a source code in order for a developer to correct a modified source code, which is not equivalent, to be equivalent when a verification result is not equivalent, in a source code equivalence verification device using symbolic execution.

### Solutions to Problem

A source code equivalence verification device to be disclosed includes: a symbolic execution calculation unit performing symbolic execution with respect to each of an original source code and a modified source code; an equivalence verification expression generation unit generating an equivalence verification expression of the original source code and the modified source code by using a symbolic execution result of the symbolic execution calculation unit; an equivalence verification expression verification unit verifying the equivalence verification expression generated by the equivalence verification expression generation unit; a correction candidate generation unit generating a correction candidate for allowing the original source code to be equivalent to the modified source code in a case where the original source code is not equivalent to the modified source code as a verification result of the equivalence verification expression of the equivalence verification expression verification unit; and a verification result generation unit generating a verification result report by using the verification result of the equivalence verification expression verification unit and the correction candidate of the correction candidate generation unit.

### Advantageous Effects of Invention

According to the source code equivalence verification device to be disclosed, it is possible for the developer to confirm a portion to be corrected in order to allow the original source code to be equivalent to the modified source code, on the source code.

### BRIEF DESCRIPTION OF THE DRAWINGS

FIG. 1 is an example of an original source code used for source code equivalence verification.

FIG. 2 is an example of a structural graph of a result obtained by performing source code analysis with respect to the source code.

FIG. 3 is an example of an execution tree of a result obtained by performing symbolic execution with respect to the source code.

FIG. 4 is a hardware configuration of a source code equivalence verification device of Example 1.

FIG. 5 is a software configuration of the source code equivalence verification device of Example 1.

FIG. 6 is a functional configuration of the source code equivalence verification device.

FIG. 7 is a configuration and a data flow of a control unit and a storage unit of the source code equivalence verification device.

FIG. 8 is a processing flowchart of the source code equivalence verification device.

FIG. 9 is an example of a modified source code used for the source code equivalence verification.

FIG. 10 is an example of an execution tree of a result obtained by performing the symbolic execution with respect to the source code.

FIG. 11 is a processing flowchart of an equivalence verification expression generation unit.

FIG. 12 is an example of a verification result of each path equivalence verification expression of the equivalence verification expression verification unit.

FIG. 13 is an example of a verification result report.

FIG. 14 is an example of the modified source code which is modified not to be equivalent.

FIG. 15 is an example of an execution tree of a result obtained by performing the symbolic execution with respect to the source code.

FIG. 16 is an example of the verification result of each of the path equivalence verification expressions.

FIG. 17 is a processing flowchart of a part of a correction candidate generation unit.

FIG. 18 is an example of a verification table.

FIG. 19 is an example of a snapshot resolution operation and a variable state modification operation.

FIG. 20 is an example of the verification table to which the snapshot resolution operation is applied.

FIG. 21 is an example of the verification table to which the variable state modification operation is applied.

FIG. 22 is an example of the verification result report.

### DESCRIPTION OF EMBODIMENTS

Symbolic execution, which is a technology to be the premise of this embodiment will be described. The symbolic execution is a technology in which when a source code is verified, the execution is performed by using a symbol, instead of executing the source code while assigning a specific value to a variable (an input variable, a global variable, and the like) used in the source code, and an input and output relationship of the source code is obtained by using a combination (hereinafter, also referred to as a snapshot) between a state of the variable (hereinafter, also referred to as a variable state) in an execution process of the source code and a condition expression (hereinafter, also referred to as a path restriction) for passing through the path in the source code.

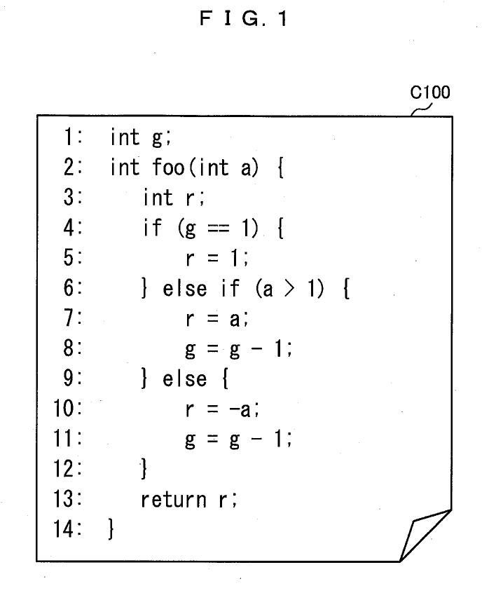

According to the symbolic execution, it is possible to verify the source code by covering all paths which can be obtained by the source code. FIG. 1 is an example of an original source code used for source code equivalence verification. Hereinafter, a source code C100 written in a C language in FIG. 1 will be described by taking a case where the symbolic execution is performed by using an information processing device as an example.

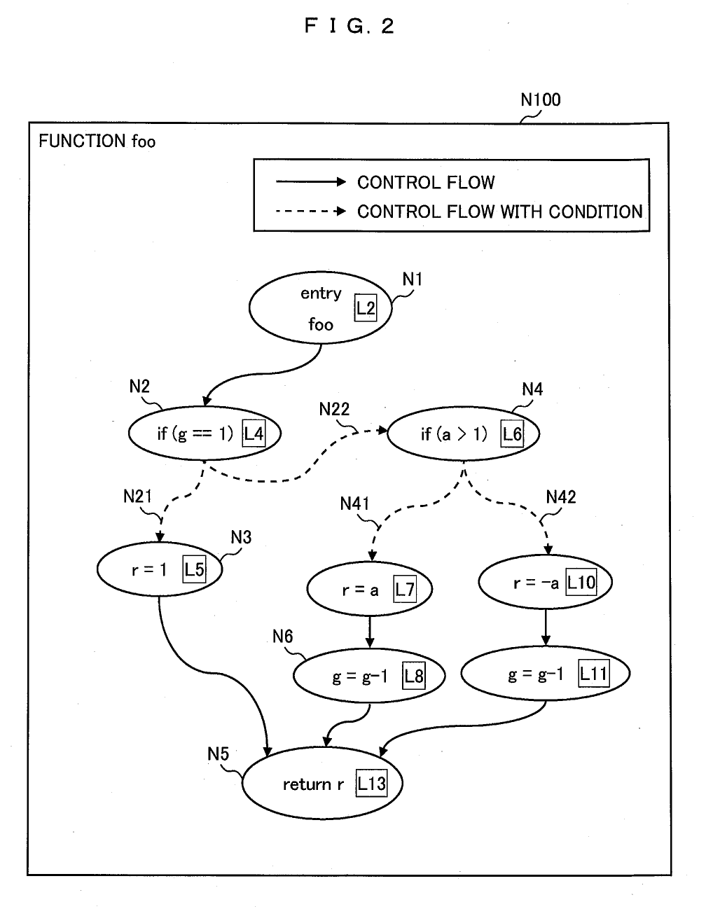

FIG. 2 is an example of a structural graph of a result obtained by performing source code analysis with respect to the source code. In the symbolic execution, the information processing device performs lexical analysis or syntactic analysis, which is identical to a compilation, by using a first source code C100 as a target, and generates a structural graph N100 illustrated in FIG. 2. The structural graph N100 illustrates a control flow of each node of an abstract syntactic tree (a data structure of a tree structure in which information irrelevant to the meaning of the language is eliminated from the syntactic tree, and only information relevant to the meaning is taken out (abstracted)) of the source code, a solid arrow illustrates a control flow without a condition, and a dashed arrow illustrates a control flow with a condition.

The structural graph N100 of a function foo illustrated in FIG. 2, illustrates each control flow which is started from a node N1 corresponding to an entry point of the function and is ended at a node N5 corresponding to a return statement, which is an exit of the function. In addition, a plurality of control flows with a condition are issued from a node N2 corresponding to an if statement, and a different control flow is passed according to establishment/non-establishment of the condition of the if statement.

In a case where the structural graph N100 is generated, the information processing device applies positional information on the source code C100 corresponding to each of the nodes. In the example illustrated in FIG. 2, the information processing device applies a row number in the source code C100 as the positional information. For example, it is known that positional information of L4 is applied to the node N2, and the corresponding if statement is described in the fourth row of the source code C100.

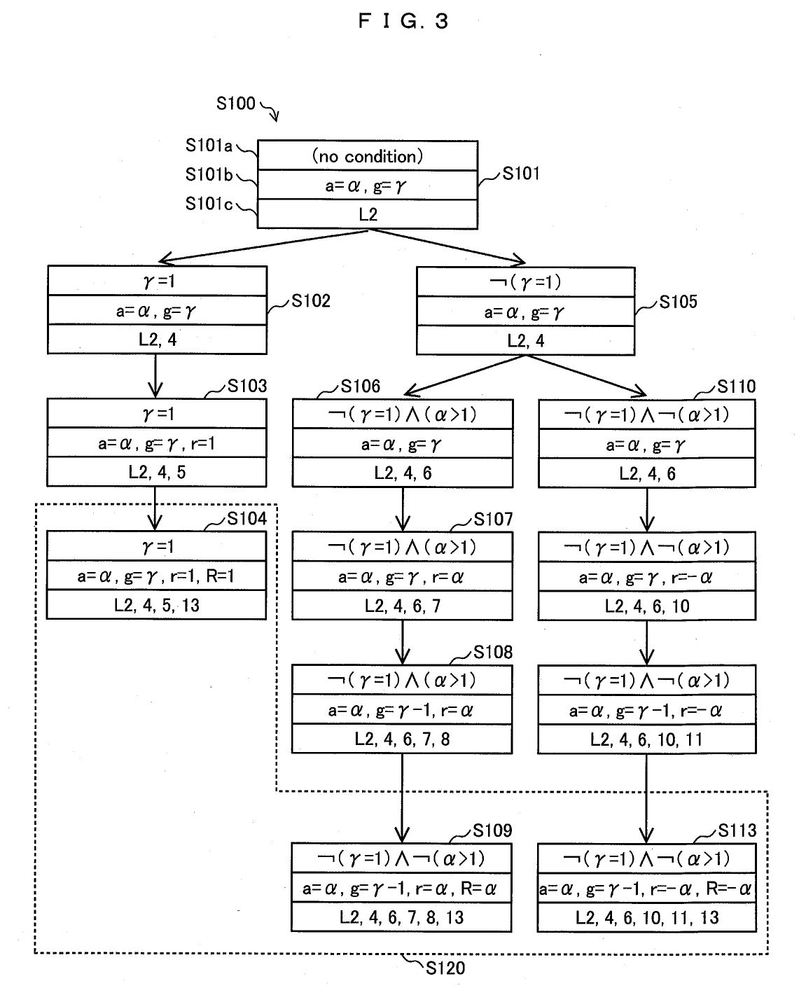

FIG. 3 is an example of an execution tree of a result obtained by performing the symbolic execution with respect to the source code. The information processing device generates an execution tree S100 illustrated in FIG. 3, based on the structural graph N100. Each of the nodes of the execution tree S100 represents the combination described above between the path restriction (an upper column) and the variable state (a middle column), and the positional information (a lower column) representing a position on the source code, which is passed. A root node S101 of the execution tree S100 corresponds to an initial state of the execution of the source code. The information processing device adds a new node to the execution tree S100 whenever the variable state is updated according to the execution of the source code.

When the execution tree S100 is generated, the information processing device allocates a symbolic variable corresponding to the value of a variable, which is an input variable of the function foo. The value of the variable, which is the input variable, is the value of a variable, which is applied from the outside of the function and is affected by the operation of the function, and includes an argument of the function or a global variable accessing in the function.

In the exemplified source code C100, an argument a of the function and the global variable g are the input variable. In this example, the information processing device allocates “α” and “γ” to the variables a and g as the symbolic variable.

The information processing device generates the root node S101 in the execution tree S100, based on the node N1 of the structural graph N100. In this example, the information processing device sets “no condition” representing “no restriction” to a path restriction (the upper column) S101a of the root node S101, and sets “a=α, g=γ” representing the symbolic variables a and y to which each of the values of the input variables a and g is allocated to a variable state (the middle column) S101b. In addition, positional information L2 acquired from the node N1 is set to positional information (the lower column) S101c.

The information processing device executes processing based on the next node N2 on the control flow of the node N1 in the structural graph N100. The node N2 is a condition branch node including control flows N21 and N22 with two conditions, and the information processing device generates a child node S102 corresponding to the control flow N21 with a condition and a child node S105 corresponding to the control flow N22 with a condition, as a child node of the node S101, respectively.

A condition expression in the node N2 is “g==1”, and the variable state of the variable g in S101b is γ, and thus, a branch condition in the control flow N21 with a condition can be represented by “γ=1”. For this reason, the path restriction (the upper column) of the node S102 is set to “γ=1” by being combined with the path restriction of “no restriction” in S101a.

The variable state (the middle column) in the node S102 is similarly set to the variable state S101b of a parent node since the variable state is not changed according to the if statement. In addition, the positional information (the lower column) is added to the positional information S101c of the parent node S101, and is added with positional information (L4) of the node N2, and thus becomes “L2, 4” which represents that the second row and the fourth row of the source code are passed.

The branch condition of the control flow N22 with a condition can be represented by “¬ (γ=1)” since the control flow N22 is a flow corresponding to a case where the condition of the if statement is not established. For this reason, the path restriction (the upper column) in the node S105 is set to “¬ (γ=1)” by being combined with the path restriction of “no restriction” in S101a.

The variable state (the middle column) in the node S105 is similarly set to the variable state S101b of the parent node since the variable state is not changed according to the if statement. In addition, the positional information (the lower column) is added to the positional information S101c of the parent node, and is added with the positional information (L4) of the node N2, and thus, becomes “L2, 4”.

The information processing device executes processing based on N3, which is the next node on the control flow N21 of the node N2. The information processing device generates a child node S103 of S102 as the node in the execution tree S100 corresponding to the node N3.

In the node S103, there is no condition branch, and thus, the path restriction (the upper column) is similarly set to S102. In addition, in node N3, a value of 1 is assigned to the variable r, and thus, “r=1” is added to the variable state (the middle column). In the positional information (the lower column), “L5”, which is the positional information of the node N3, is added to the positional information in S102.

The information processing device executes processing based on N5, which is the next node on the control flow of N3. A child node S104 of S103 is generated as the node in the execution tree S100 corresponding to the node N5. The node N5 corresponds to the return statement taking the variable r as a return value, and thus, “R=1” where 1, which is a current value of the variable r, is allocated to a variable R representing the return value, is added to the variable state (the middle column). The execution of the function is ended by the return statement, and thus, in the execution tree S100, the generation of the branch is ended, and the execution proceeds to the generation of the branch which has not been generated.

The information processing device executes processing based on N4, which is the next node on the control flow N22 of N2. The node N4 is a condition branch node including control flows N41 and N42 with two conditions, and the information processing device generates a child node S106 corresponding to the control flow N41 with a condition and a child node S110 corresponding to the control flow N42 with a condition, respectively, under the node S105.

The condition expression of the if statement in the node N4 is “a>1”, and a value corresponding to a according to the variable state is α, and thus, the branch condition in the control flow N41 with a condition is represented by “α>1”. For this reason, the path restriction (the upper column) in S106 is set to “¬(γ=1) ∧ (α>1)”, which is a conjunction between the path restrictions of “¬ (γ=1)” and “α>1” in S105.

Hereinafter, the information processing device repeats the operation described above with respect to the branch until the generation of all of the branches is ended.

In processing with respect to a node N6, the information processing device generates a child node S108 of a node S107.

In the node N6, the value of the variable g is updated to g−1. At this time, it is known that a value corresponding to the variable g is γ from the variable state (the middle column) of S107. Therefore, in the child node S108, the information processing device updates the variable state (the middle column) with respect to the variable g to “g=γ−1”. Thus, the variable state retained in the format of an expression rather than a specific value, with respect to calculation including the symbolic variable.

The information processing device finally obtains the execution tree S100 as illustrated in FIG. 3 from the structural graph N100 illustrated in FIG. 2 according to the operation described above. In the symbolic execution, the child node according to the condition branch is generated in the execution tree in order to cover all of the control flows to be obtained.

A leaf node in the execution tree is capable of representing that an aggregation of sets of conditions (the path restrictions) with respect to an input value of the source code and states (the variable state) of an output variable. In the following description, the leaf node of the execution tree at a time point where the symbolic execution is ended is referred to as a “snapshot”, and the aggregation of the snapshots is referred to as a “symbolic execution summary”. Here, in the variables included in the variable state, a local variable (including the argument of the function) is cancelled at a time point where the execution of the function is completed, and thus, the variable state of the local variable is excluded from the snapshot and the symbolic execution summary.

The leaf node in the execution tree S100 is three nodes of S104, S109, and S113, and such nodes are respectively the snapshots, and the aggregation thereof is a symbolic execution summary S120. Here, the variable state of the variables r and a, which are the local variable, is excluded.

In this example, the symbolic execution has been described by using the source code written in the C language, but is not limited to the source code written in the C language, and can be similarly performed with respect to a source code written by using other programming languages.

### EXAMPLE 1

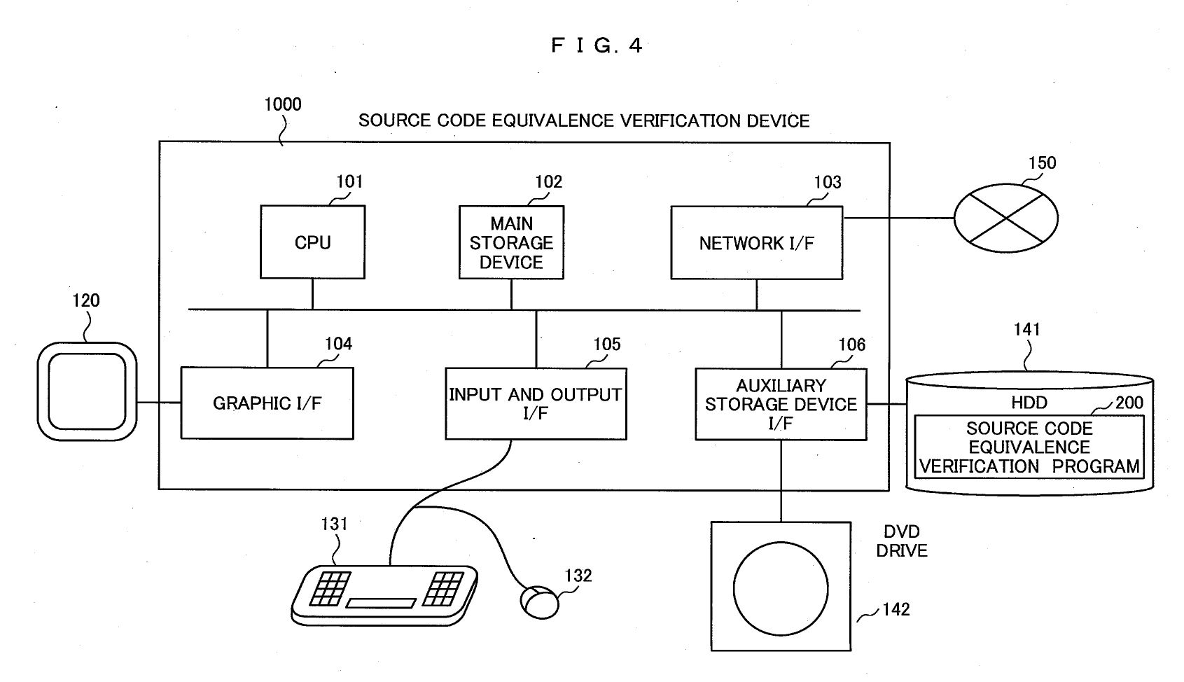

Hereinafter, a configuration and processing of a source code equivalence verification device 1000 of Example 1 will be described by using FIG. 4 to FIG. 13.

FIG. 4 is a hardware configuration of the source code equivalence verification device 1000 of this example. The source code equivalence verification device, for example, is realized by a personal computer, which is a general information processing device as illustrated in FIG. 4. The source code equivalence verification device 1000 is in the shape where a central processing unit (CPU) 101, a main storage device 102, a network I/F 103, a graphic I/F 104, an input and output I/F 105, and an auxiliary storage device I/F 106 are coupled to each other through a bus.

The CPU 101 controls each of the units of the source code equivalence verification device 1000, loads a source code equivalence verification program 200 to the main storage device 102, and executes the program.

In general, the main storage device 102 is configured of a volatile memory such as a RAM, and the program executed and data to be referred by the CPU 101 are loaded from an auxiliary storage device and are stored.

The network I/F 103 is an interface for being connected to an external network 150.

The graphic I/F 104 is an interface for connecting a display device 120 such as a liquid crystal display (LCD).

The input and output I/F 105 is an interface for connecting an input and output device. In the example of FIG. 4, a keyboard 131 and a mouse 132, which is a pointing device, are connected to the input and output I/F 105.

The auxiliary storage device I/F 106 is an interface for connecting an auxiliary storage device such as a hard disk drive (HDD) 141 or a digital versatile disk (DVD) drive device 142.

The HDD 141 has a large storage capacity, and stores the source code equivalence verification program 200 for executing processing of this example.

The DVD drive device 142 is a device which writes data in an optical device such as a DVD or a CD, and reads the data from the optical device, and for example, a program provided by a CD-ROM can be installed as the source code equivalence verification program 200.

The test data generate device 1000 of this performance installs the source code equivalence verification program 200 in a personal computer as described above, and executes each function.

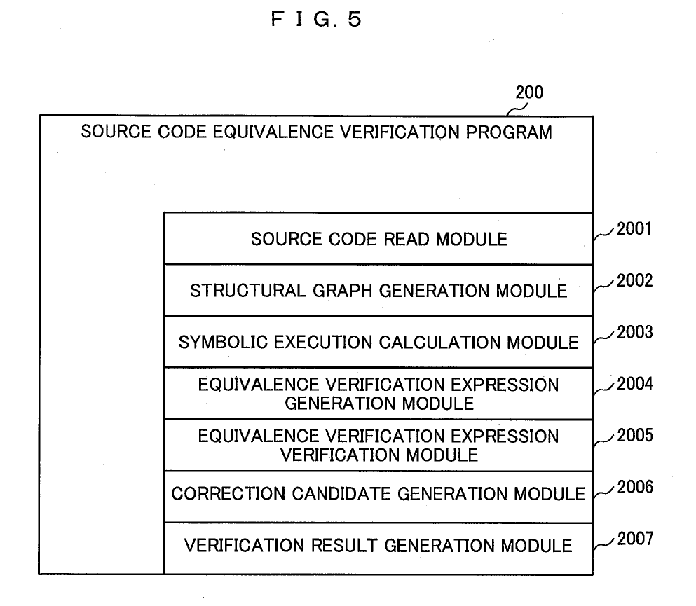

FIG. 5 is a software configuration of the source code equivalence verification device of this example. The source code equivalence verification program 200 executed by the source code equivalence verification device 1000 includes a source code read module 2001, a structural graph generation module 2002, a symbolic execution calculation module 2003, an equivalence verification expression generation module 2004, an equivalence verification expression verification module 2005, a correction candidate generation module 2006, and a verification result display module 2007.

Furthermore, the program equivalence verification program 200 is application software operated on an operating system (OS), and includes the OS or a library program as the software configuration of the source code equivalence verification device, but is omitted in FIG. 5.

The source code read module 2001 is a module which reads an original source code and a modified source code, which are a verification target, from the HDD or other calculators, and stores the codes in the storage unit.

The structural graph generation module 2002 is a modules which performs the lexical analysis and the syntactic analysis with respect to the source code (for example, C100 described above), and extracts the control flow, and thus, generates the structural graph (for example, N100 described above).

The symbolic execution calculation module 2003 is a module which calculates the execution tree (for example, S100 described above) based on the structural graph generated by the structural graph generation module 2002, by performing the symbolic execution, and generates the symbolic execution summary (for example, S120 described above) in which the leaf nodes are collected.

The equivalence determination expression generation module 2004 is a module which generates a path restriction conjunction expression, a path restriction equivalent determination expression, and a path equivalence verification expression for determining the equivalence of the original source code and the modified source code from the symbolic execution summary of the original source code and the symbolic execution summary of the modified source code generated by the symbolic execution calculation module 2003, with respect to each combination of the snapshots included in the symbolic execution summary.

The equivalence verification expression verification module 2005 is a module which solves the path restriction conjunction expression, the path restriction equivalent determination expression, and the path equivalence verification expression generated by the equivalence determination expression generation module 2004 as a satisfiability problem by using a satisfiability (SAT) solver or a satisfiability modulo theories (SMT) solver.

The correction candidate generation module 2006 is a module which analyzes which combination of the snapshots included in the symbolic execution summary of the original source code and the symbolic execution summary of the modified source code has non-equivalence by using a verification result output from the equivalence verification expression verification module 2005, and derives a correction candidate for being logically equivalent at the time of non-equivalence.

The verification result generation module 2007 is a module which generates a verification result report by using the verification result output from the equivalence verification expression verification module 2005, the correction candidate output from the correction candidate generation module 2006, the symbolic execution summary, or the information of the source code, and displays or notifies the verification result report.

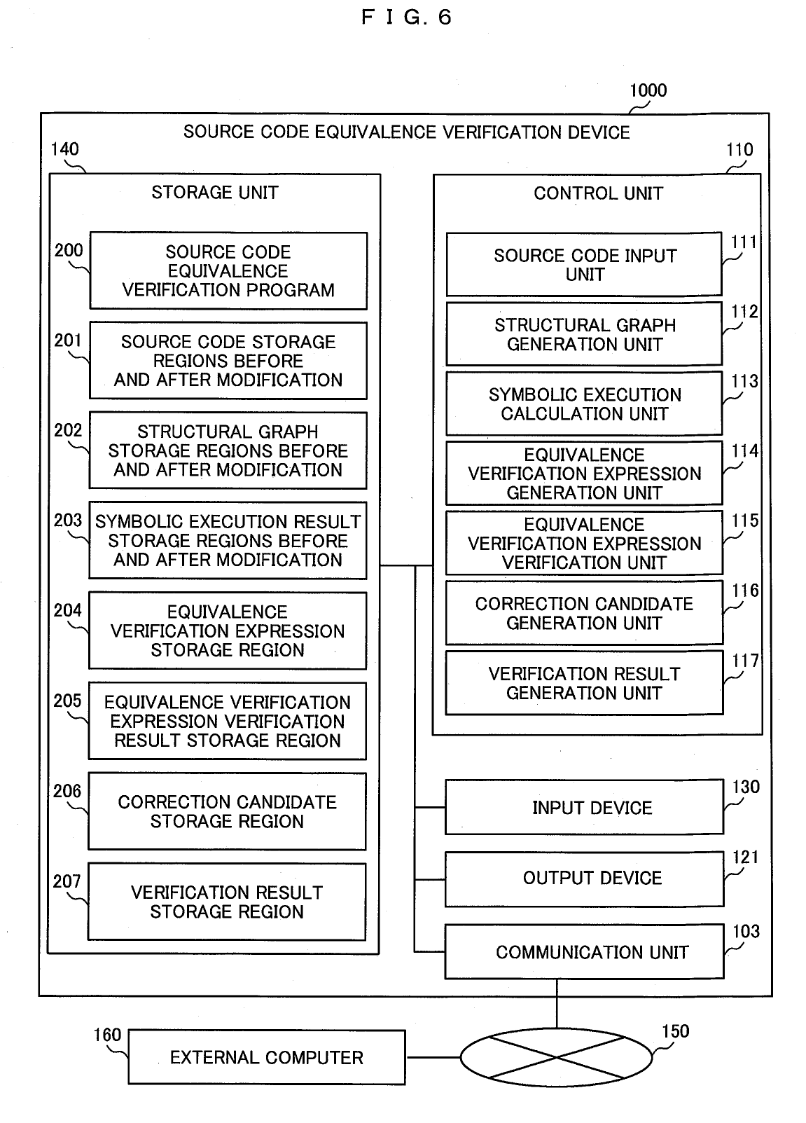

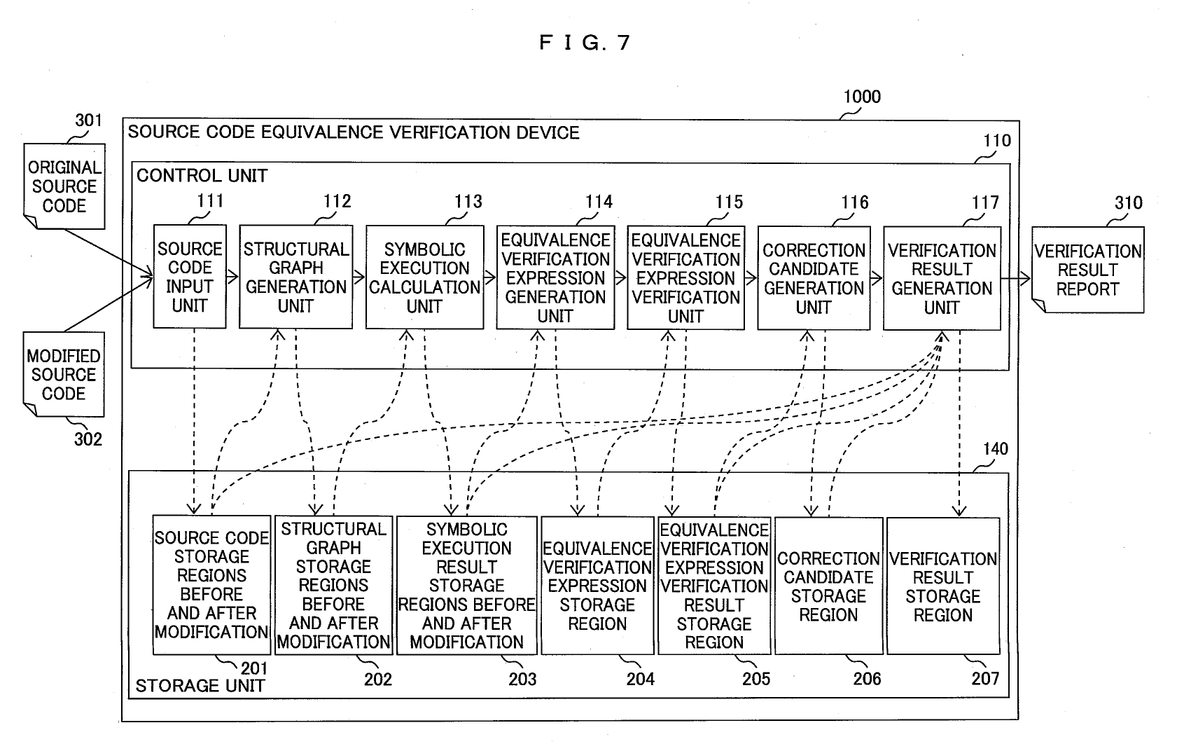

FIG. 6 is a functional configuration of the source code equivalence verification device 1000. The control unit 110 is realized by the CPU 101 of FIG. 4 and the main storage device 102, and a storage unit 140 is mainly realized by the HDD 141 of FIG. 4, and may include the main storage device 102. An input device 130 includes the input and output I/F 105, the keyboard 131, and the mouse 132 of FIG. 4, and the like, and may have a reading configuration from the DVD drive device 142 through the auxiliary storage device I/F 106. An output device 121 includes the graphic I/F 104, the display device 120, and the like, and may have a writing configuration to the DVD drive device 142 through the auxiliary storage device I/F 106. The communication unit 103 represents the network I/F 103 of FIG. 4, and for example, is connected to an external computer 160 through the network 150. The details of the control unit 110 and the storage unit 140 of FIG. 6 will be described by using FIG. 7.

FIG. 7 is a configuration and a data flow of the control unit 110 and the storage unit 140 of the source code equivalence verification device 1000. A source code input unit 111 reads an original source code 301 and a modified source code 302, which are the verification target, and stores the codes in source code storage regions 201 before and after modification, respectively.

In this example, an example will be described in which the original source code 301 and the modified source code 302 are written in the C language, but source codes written in other programming languages can be used by using a structural graph generation unit 112 and a symbolic execution calculation unit 113 corresponding to the programming languages. In addition, different programming languages may be used in the original source code 301 and the modified source code 302.

The structural graph generation unit 112 executes the source code analysis with respect to each of the original source code and the modified source code, which are stored in the source code storage regions 201 before and after modification, and stores the original structural graph and the modified structural graph, which are an analysis result, in structural graph storage regions 202 before and after modification.

The symbolic execution calculation unit 113 performs the symbolic execution with respect to each of the original structural graph and the modified structural graph, which are stored in the structural graph storage regions 202 before and after modification, and stores the symbolic execution summary, which is a calculation result (a symbolic execution result), in symbolic execution result storage regions 203 before and after modification.

An equivalence verification expression generation unit 114 generates the path restriction conjunction expression, the path restriction equivalent determination expression, and the path equivalence verification expression for determining the equivalence of the original source code and the modified source code from the symbolic execution summary of the original source code and the symbolic execution summary of the modified source code, which are stored in the symbolic execution result storage regions 203 before and after modification and are symbolic execution results before and after modification, with respect to each combination of the snapshots included in the symbolic execution summary, and stores the expressions in an equivalence verification expression storage region 204.

An equivalence verification expression verification unit 115 executes the verification with respect to the path restriction conjunction expression, the path restriction equivalent determination expression, and the path equivalence verification expression, which are stored in the equivalence verification expression storage region 204, and stores the verification result in an equivalence verification expression result storage region 205.

A correction candidate generation unit 116 determines which combination of the snapshots have non-equivalence in a case where the verification result of any one of the path restriction conjunction expression, the path restriction equivalent determination expression, and the path equivalence verification expression, which are stored in the equivalence verification expression storage region 204 is not equivalent, derives an operation for being equivalent, and stores the operation in a correction candidate storage region 206 as the correction candidate.

A verification result generation unit 117 generates a verification result report 310 by using the verification results of the path restriction conjunction expression, the path restriction equivalent determination expression, and the equivalence verification expression, the correction candidate, the symbolic execution summary, or the information of the source code, stores the verification result report 310 in a verification result storage region 207, and displays the verification result report 310 on a screen by using the output device 121 or transmits the verification result report 310 to the external computer 160 by using the communication unit 103.

As it is obvious from the above description, the operation of each of the units included in the control unit 110 is realized by executing each of the modules of the source code equivalence verification program illustrated in FIG. 5 with the source code equivalence verification device 1000.

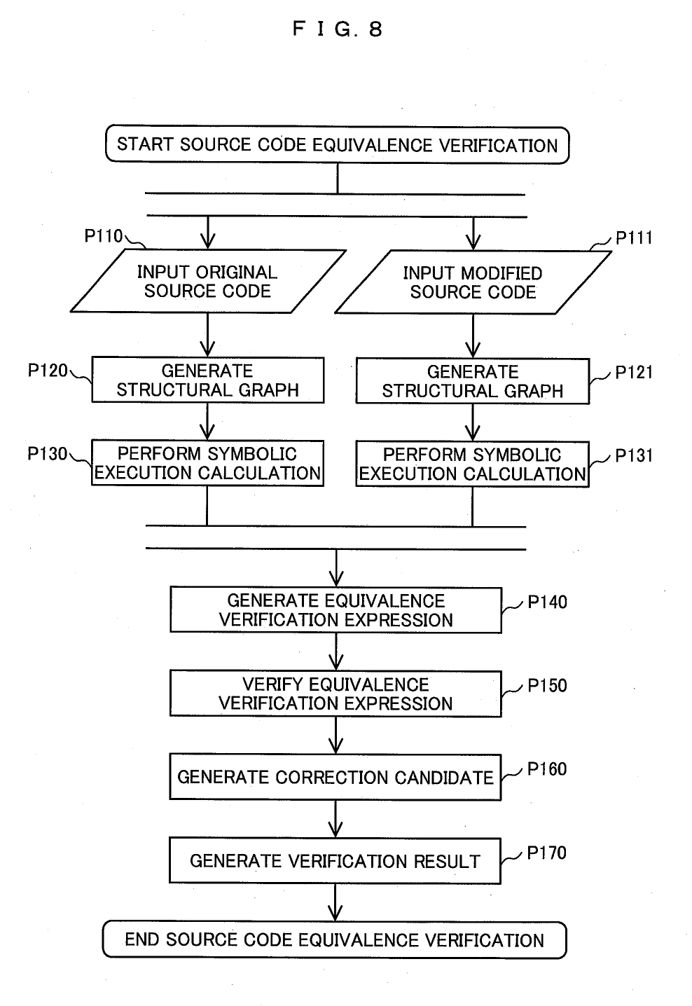

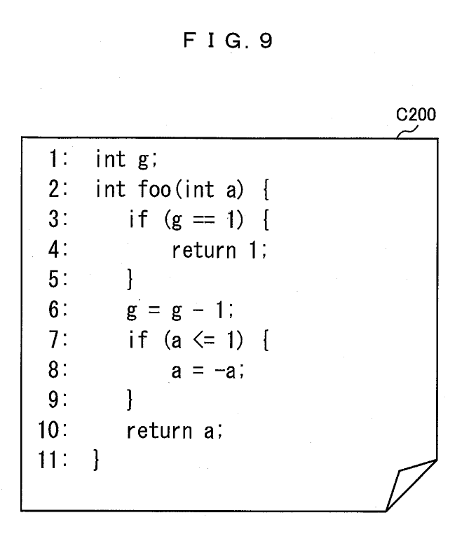

FIG. 8 is a processing flowchart of the source code equivalence verification device. A case where the original source code C100 illustrated in FIG. 1 is input as the original source code, and a modified source code C200 illustrated in FIG. 9, which is modified to be equivalent to C100, is input as the modified source code will be described as an example.

The source code input unit 111 reads the original source code 301, which is the verification target, and stores the original source code 301 in each of the source code storage regions 201 before and after modification (P110). The structural graph generation unit 112 executes the source code analysis with respect to the original source code stored in the source code storage regions 201 before and after modification, generates the original structural graph N100, which is the analysis result, and stores the original structural graph N100 in the structural graph storage regions 202 before and after modification (P120). The symbolic execution calculation unit 113 performs the symbolic execution with respect to the original structural graph stored in the structural graph storage regions 202 before and after modification, generates the execution result as the original symbolic execution summary S120, and stores the execution result in the symbolic execution result storage regions 203 before and after modification (P130).

The same applies to the modified source code 302, and thus, processing (P111) of the source code input unit 111, processing (P121) of the structural graph generate processing unit 112, and processing (P131) of the symbolic execution calculation unit 113 are executed, the modified symbolic execution summary is stored in the symbolic execution result storage regions 203 before and after modification.

The processing steps P110, P120, and P130 with respect to the original source code 301 can be independently executed from the processing steps P111, P121, and P131 with respect to the modified source code 302, and thus, the original source code 301 and the modified source code 302 may be processed in parallel.

In addition, in a case where the processing is previously executed with respect to the source code of the same contents, the previous processing result stored in the symbolic execution result storage regions 203 before and after modification is used again, and thus, it is possible to omit the structural graph generation and the symbolic execution calculation.

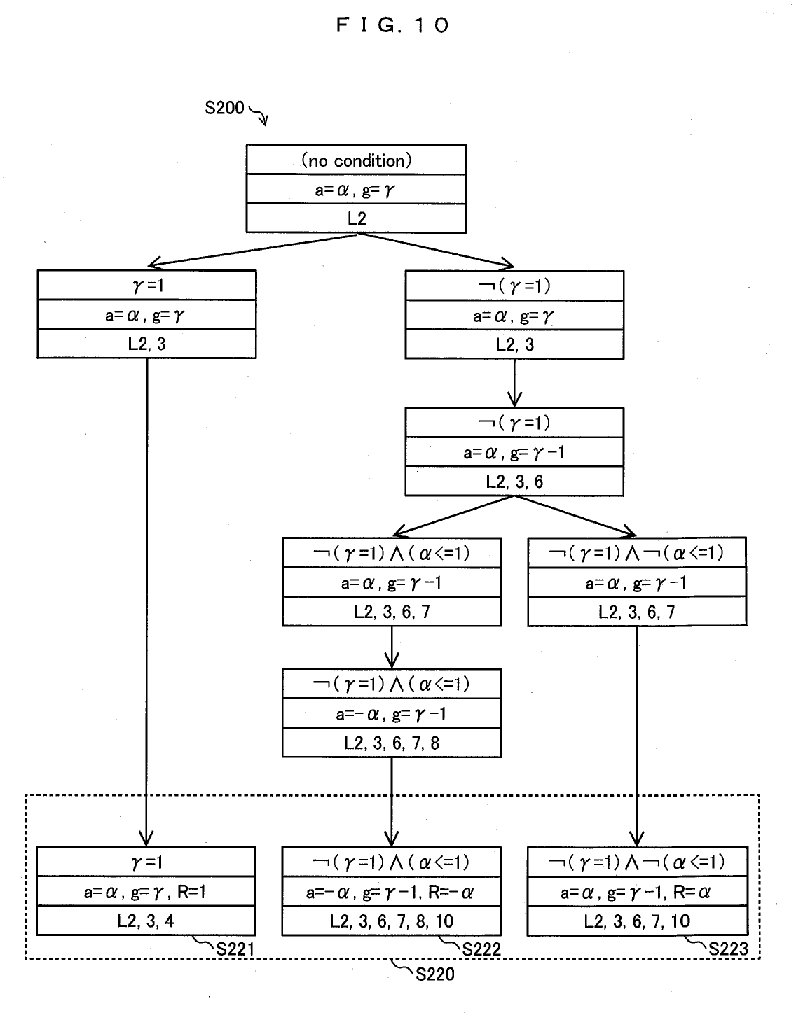

The equivalence verification expression generation unit 114 generates an equivalence verification expression by using the symbolic execution summary of the original source code and the symbolic execution summary of the modified source code (P140). FIG. 10 is an example of an execution tree of a result obtained by performing the symbolic execution with respect to the modified source code C200. A specific processing procedure will be described by using the symbolic execution summary S120 illustrated in FIG. 3, which is generated from the original source code C100 illustrated in FIG. 1, and a symbolic execution summary S220 illustrated in FIG. 10, which is generated from the modified source code C200 illustrated in FIG. 9.

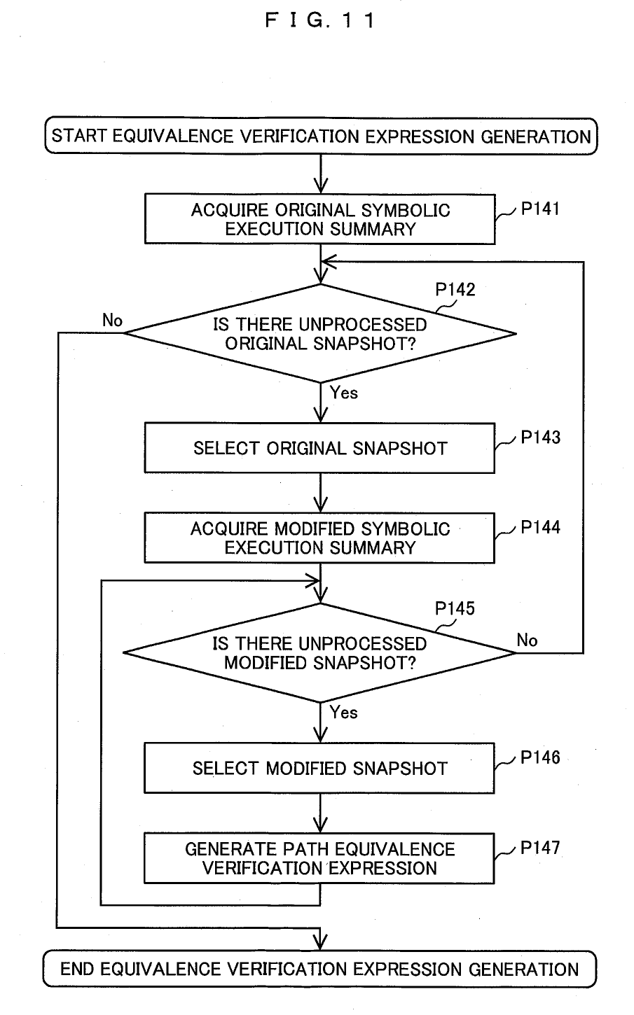

FIG. 11 is a processing flowchart of the equivalence verification expression generation unit 114. The equivalence verification expression generation unit 114 acquires the symbolic execution summary of the original source code from the symbolic execution result storage regions 203 before and after modification (P141). Processing described below is executed with respect to each snapshot of the original symbolic execution summary, and in a case where there is no unprocessed original snapshot (P142), the equivalence verification expression generation unit 114 ends the processing.

The equivalence verification expression generation unit 114 selects one snapshot from the original symbolic execution summary (P143). The equivalence verification expression generation unit 114 acquires the modified symbolic execution summary from the symbolic execution result storage regions 203 before and after modification (P144). The equivalence verification expression generation unit 114 selects one snapshot with respect to the modified symbolic execution summary (P146), and generates the path equivalence verification expression (P147). In a case where there is no unprocessed modified snapshot (P145), the equivalence verification expression generation unit 114 returns to Step P142, and thus, the equivalence verification expression generation unit 114 generates the path equivalence verification expression with respect to all combinations between the original snapshot and the modified snapshot.

The equivalence verification expression generation unit 114 generates the snapshot restriction expression by acquiring a conjunction between a path restriction and an equal condition of each variable state with respect to each of the snapshots of the symbolic execution summary.

For example, a restriction expression such as (γ=1) ∧ (g=γ) ∧ (R=1), ¬ (γ=1) ∧ (α>1) ∧ (g=γ−1) ∧ (R=α), and ¬ (γ=1) ∧ ¬ (α>1) ∧ (g=γ−1) ∧ (R=−α) is generated with respect to the snapshots S104, S109, and S113. At this time, as described above, an equal restriction of the variable state with respect to the variable r and the variable a, which are the local variable is excluded.

Further, the equivalence verification expression generation unit 114 generates the path restriction conjunction expression for determining whether or not there is a portion overlapping with the path restrictions of both of the selected original snapshot and the selected modified snapshot, the path restriction equivalent determination expression for determining whether or not the path restrictions of the selected original snapshot and the selected modified snapshot are equivalent to each other, and the path equivalence verification expression for verifying the equivalence in the range of the path corresponding to the selected original snapshot and the selected modified snapshot, and records the expressions in the equivalence verification expression storage region 204.

The path restriction conjunction expression is a conjunction between the path restriction of the selected original snapshot and the path restriction of the selected modified snapshot. When the path restriction conjunction expression is capable of being satisfied, an input satisfying both of the path restrictions is generated, and thus, it is known that the portion overlapping with the path restrictions is generated.

The path restriction equivalence determination expression is an expression of verifying that there is no portion not overlapping with the path restrictions after the portion overlapping with the path restrictions is generated in advance when the path restriction conjunction expression is satisfied. When the path restriction of the selected original snapshot is set to A, and the path restriction of the modified snapshot is set to B, the path restriction equivalence determination expression is represented by (A ∧ ¬ B) ∨ (¬ A ∧ B). In a case where the expression is not capable of being satisfied, the path restriction A and the path restriction B totally overlap each other and are equivalent to each other.

The path equivalence verification expression is a conjunction in a disaffirmation expression of a conjunction of an equal restriction expression between the corresponding output variables, a snapshot restriction expression of the selected original snapshot, and a snapshot restriction expression of the selected modified snapshot. When the original source code is equivalent to the modified source code in the selected snapshot, that is, in the selected path, the output variable is equivalent to an arbitrary input variable passing through the path, and thus, the conjunction of the equal restriction between the corresponding output variables is established at all times.

For example, when the snapshot S104 in the original symbolic execution summary S120 and a snapshot S221 in the modified symbolic execution summary S220 are selected, the path restriction conjunction expression is (γ=1) ∧ (γ=1), the path restriction equivalence verification expression is ((γ=1) ∧ ¬ (γ=1)) ∨ ((γ=1) ∧ ¬ (γ=1)), and the path equivalence verification expression is ¬ ((R=R′) ∧ (g=g′)) ∧ ((γ=1) ∧ (g=γ) ∧ (R=1)) ∧ ((γ=1) ∧ (g′=γ) ∧ (R′=1)). Here, in order to avoid the collision between variable names in the original symbolic execution summary, the output variables g and R on the modified symbolic execution summary side are respectively substituted with g′ and R′.

In the explanatory example described above, one snapshot is selected at one time, and thus, the path equivalence verification expression is generated. However, a plurality of snapshots may be selected at one time. In this case, a disjunction of the snapshot restriction expression corresponding to the selected snapshot is used instead of the snapshot restriction expression used for generating the path equivalence verification expression.

In addition, in the explanatory example described above, the processing of the equivalence verification expression generation unit 114 is started after the processing of the symbolic execution calculation unit 113 is completed, but the generation of the path equivalence verification expression with respect to the combination according to the snapshot may be started at a time point where the generation of a part of the snapshot is completed during the processing of the symbolic execution calculation unit 113.

The equivalence verification expression verification unit 115 determines the satisfiability with respect to a plurality of path restriction conjunction expressions, path restriction equivalent determination expressions, and path equivalence verification expressions generated by the equivalence verification expression generation unit 114, by using a SAT solver or the like, respectively (P150). The equivalence verification expression verification unit 115 stores a result of whether or not the satisfiability is obtained with respect to each of the expressions, and a counter-example which is an example of the value of a variable to be satisfied, which is output from the solver in a case where the path equivalence verification expression is not capable of being satisfied, in the equivalence verification expression verification result storage region 205.

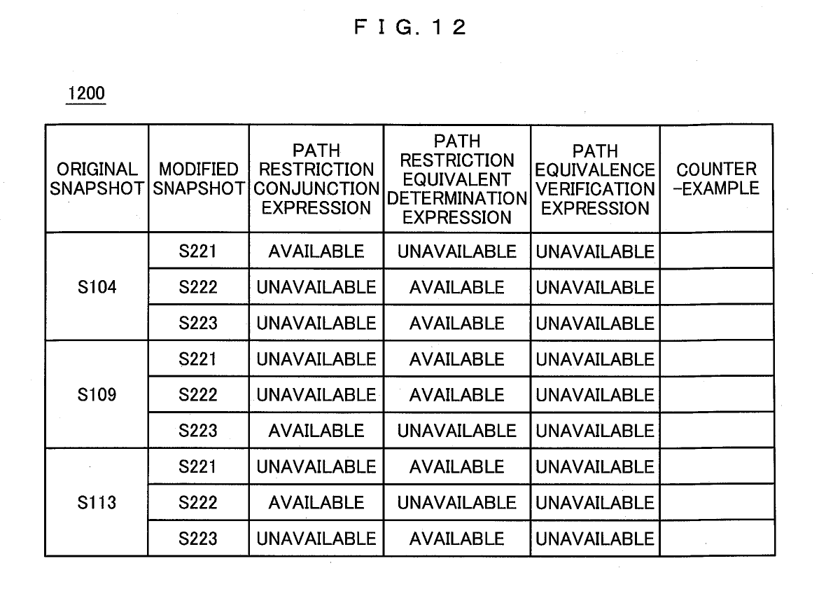

FIG. 12 is an example of a verification result 1200 of each of the path equivalence verification expressions of the equivalence verification expression verification unit 115 in this example. Among nine combinations between the original snapshot and the modified snapshot, it is determined that the path equivalence verification expression is not capable of being satisfied with respect to all of the combinations, and thus, it is determined that the modified source code C100 is equivalent to the modified source code C200.

The correction candidate generation unit 116 generates the correction operation allowing the modified source code to be equivalent to the original source code in the case of not being equivalent, but in this example, no processing is executed since it is determined that the modified source code is equivalent to the modified source code (P160).

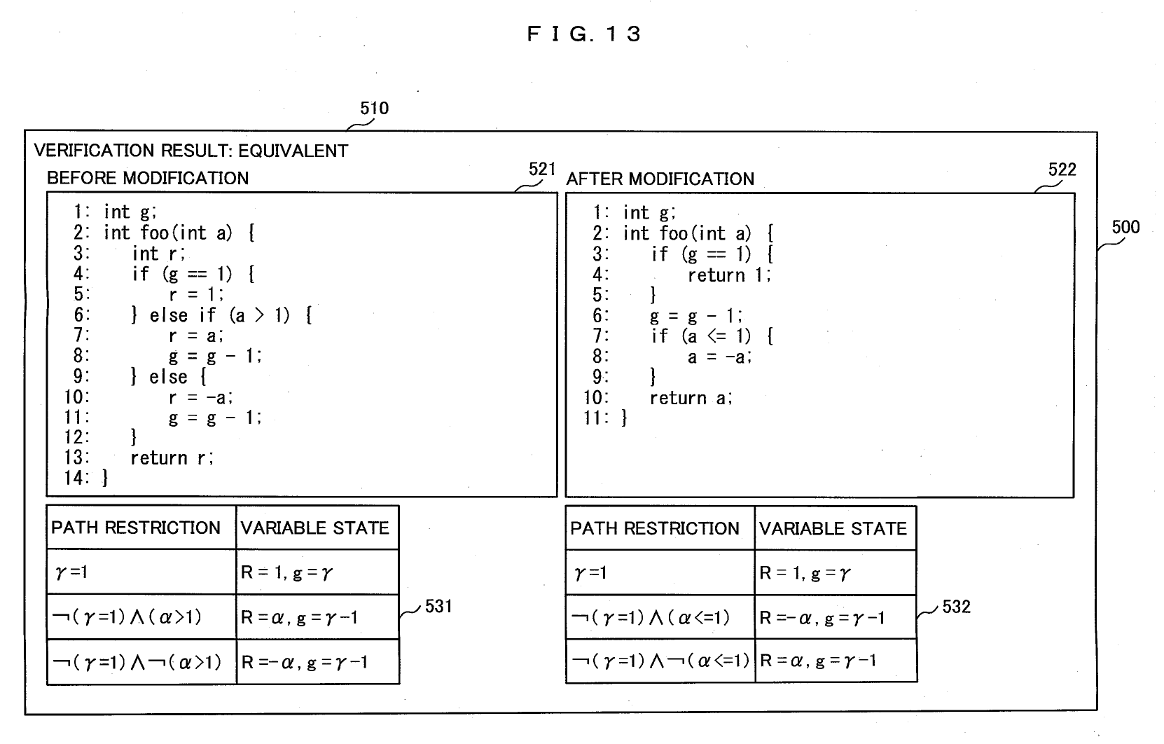

FIG. 13 is an example of the verification result report. The verification result generation unit 117 generates a verification result report 500 illustrated in FIG. 13, based on the verification result (P170).

The verification result report 500 displays “equivalent” in a case where all of the path equivalence verification expressions are not capable of being satisfied, and displays “not equivalent” in a case where any one of the path equivalence verification expressions is capable of being satisfied, as a verification result 510. In this example, it is recorded that all of the path equivalence verification expressions are not capable of being satisfied, and thus, the verification result 510 is displayed as “equivalent”.

In addition, the verification result report 500 may include displays of an original source code 521 and a modified source code 522 by using the source code information stored in the source code storage regions 201 before and after modification.

Further, the verification result report 500 may include displays of an original symbolic execution summary 531 and a modified symbolic execution summary 532 by using the symbolic execution summary information stored in the symbolic execution result storage regions 203 before and after modification. In the displays of the symbolic execution summaries 531 and 532 in FIG. 13, the path restriction and the variable state may be displayed in one row with respect to each of the snapshots.

### EXAMPLE 2

A specific example of processing of a source code equivalence verification device of example 2 will be described by using FIG. 8 and FIG. 14 to FIG. 22. In this example, the equivalence (referred to as path equivalence) between a case where a specific path of the original source code is passed and a case where a specific path of the modified source code is passed, is verified with respect to the combinations of all of the paths, and thus, the equivalence verification is realized.

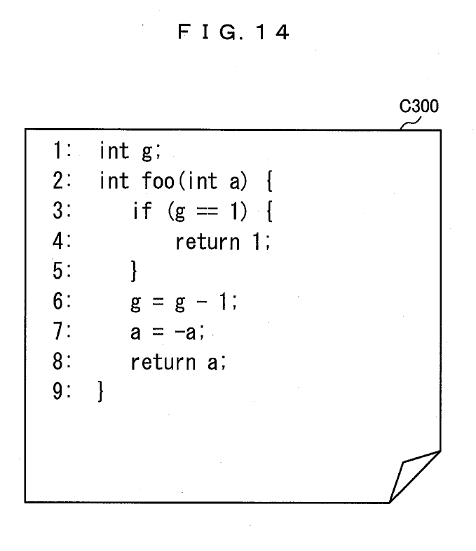

FIG. 14 is an example of the modified source code which is modified not to be equivalent. Hereinafter, a case where the original source code C100 illustrated in FIG. 1 is input as the original source code, and a modified source code C300 illustrated in FIG. 14, which is modified not to be equivalent to C100, is input as the modified source code, in the processing process of the source code equivalence verification illustrated in FIG. 8, will be described as an example.

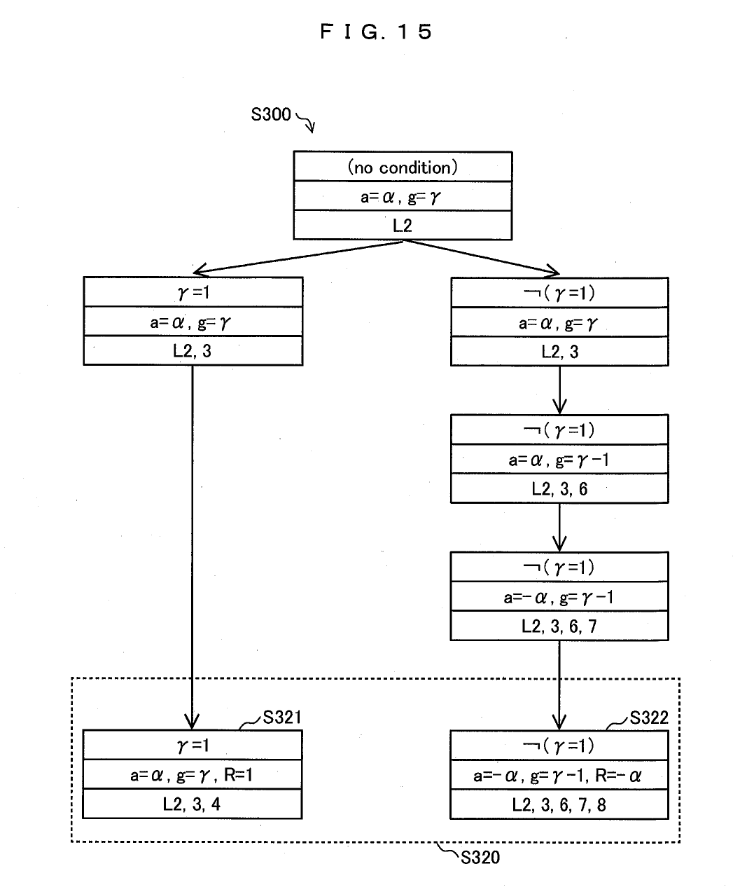

In FIG. 15, the processing contents of each of the step processings in FIG. 8 are the same as described above, and in the processing (P131) of the symbolic execution calculation unit 113, an execution tree S300 and a symbolic execution summary S320 illustrated in FIG. 15 are generated from the modified source code C300.

In the equivalence verification expression generation unit 114, as described above, the path restriction conjunction expression, the path restriction equivalent determination expression, and the path equivalence verification expression are generated with respect to each combination between the original snapshot and the modified snapshot (P140). For example, when the snapshot S109 in the original symbolic execution summary S120 and the snapshot S221 in a modified symbolic execution summary S322 are selected, the path restriction conjunction expression is (¬ (γ=1) ∧ (α>1)) ∧ ¬ (γ=1), the path restriction equivalence verification expression is ((¬ (γ=1) ∧ (α>1)) ∧ ¬ (¬ (γ=1))) ∨ (¬ (¬ (γ=1) ∧ (α>1)) ∧ ¬ (γ=1)), and the path equivalence verification expression is ¬ ((R=R′) ∧ (g=g′)) ∧ (¬ (γ=1) ∧ (α>1) ∧ (g=γ−1) ∧ (R=α)) ∧ (¬ (γ=1) ∧ (g′=γ−1) ∧ (R′=−α)).

The equivalence verification expression verification unit 115 determines the satisfiability with respect to all of the path restriction conjunction expressions, path restriction equivalent determination expressions, and path equivalence verification expressions, which are generated, by the SAT solver or the like, and thus, performs the equivalent determination.

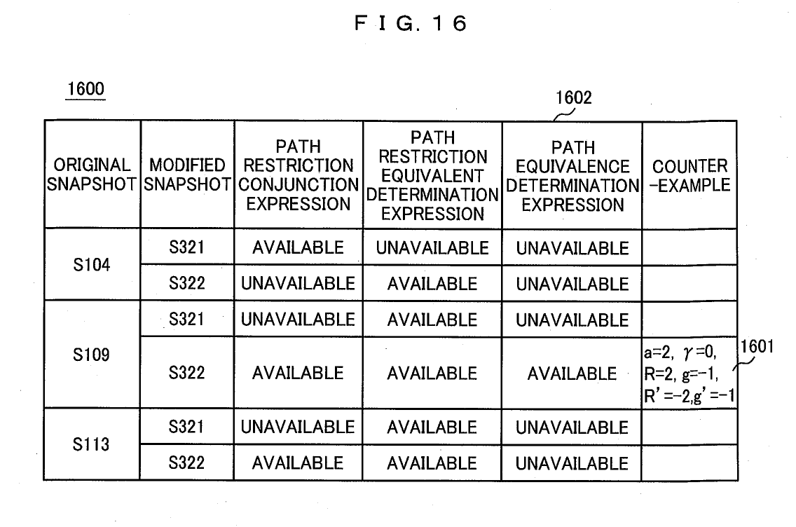

FIG. 16 is the verification result of each of the path equivalence verification expressions. For example, when the snapshot S109 in the original symbolic execution summary S120 and the snapshot S221 in the modified symbolic execution summary S322 are selected, the path equivalence determination expression is capable of being satisfied, and counter-examples such as α=2, γ=0, R=2, g=−1, R′=−2, and g′=−1 are obtained, and thus, are recorded.

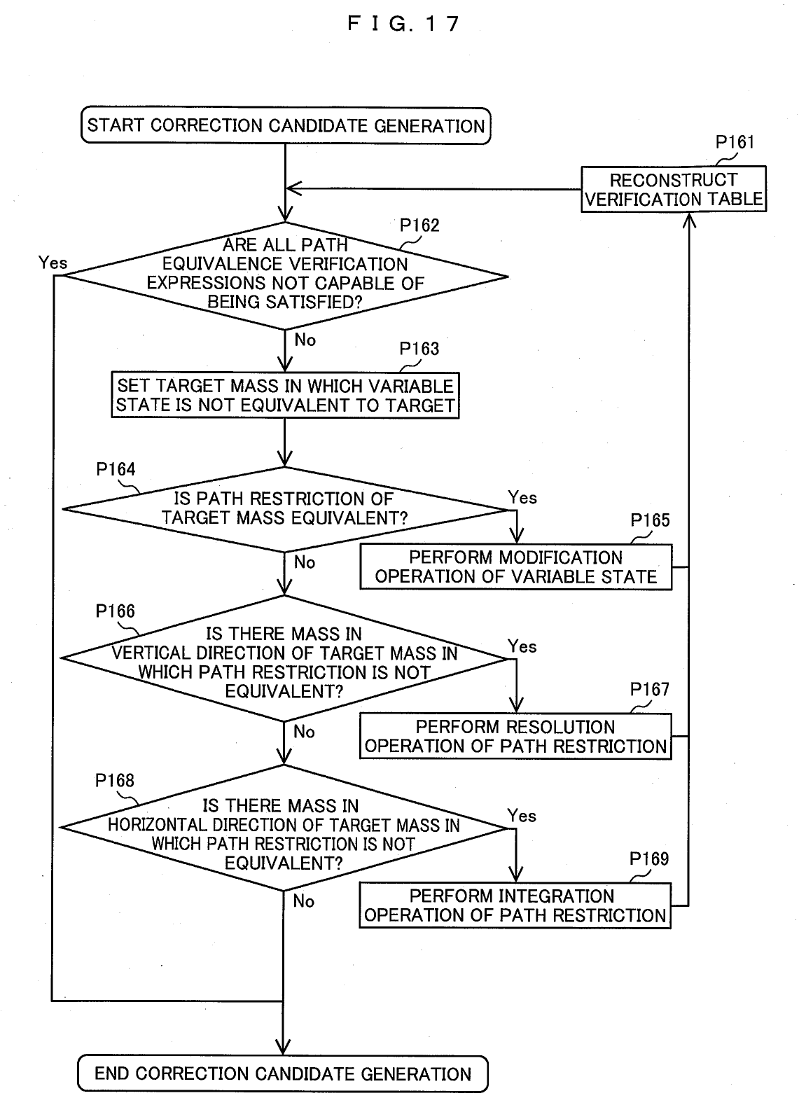

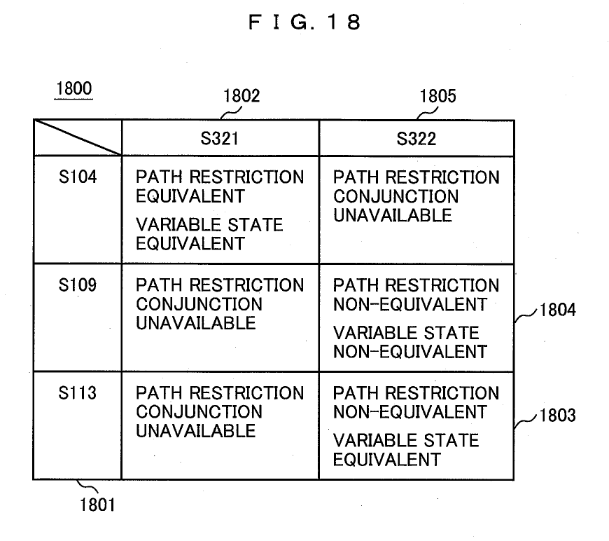

FIG. 17 is a processing flowchart in Step P160 of the correction candidate generation unit 116. The correction candidate generation unit 116 arranges the satisfaction results of each of the expressions, which are determined by the equivalence verification expression verification unit 115, in the shape of a table in which the original snapshots are arranged in a row and the modified snapshots are arranged in a column, for the sake of simplicity, and the processing will be described by using a verification table (refer to FIG. 18) in which the verification result of the equivalence verification expression verification unit 115 is described in a mass. In this example, the satisfied determination result illustrated in FIG. 16 is a verification table 1800 of FIG. 18. The original snapshots are arranged in a row direction, the modified snapshots are arranged in a column direction, and each determination result of the satisfiability with respect to the path restriction conjunction expression, the path restriction equivalent determination expression, and the path equivalence verification expression are described in a mass. In a mass where the path restriction conjunction expression is not capable of being satisfied, other determination results are omitted by setting the path restriction conjunction to be unavailable. In a case where the path restriction conjunction expression is not capable of being satisfied, a satisfaction result of the path restriction equivalent determination expression is represented. In a case where the path restriction equivalent determination expression is capable of being satisfied, the path restriction of the original snapshot is not equivalent to the path restriction of the modified snapshot, and thus, it is represented that the path restriction is not equivalent, and in a case where the path restriction equivalent determination expression is not capable of being satisfied, it is represented that the path restriction is equivalent. In a case where the path equivalence verification expression is not capable of being satisfied, it is represented that the variable output state is equivalent in the range of the path represented by the path restriction of the original snapshot and the path restriction of the modified snapshot, and thus, it is represented that the variable state is equivalent, the path equivalence verification expression is capable of being satisfied, is represented that the variable state is not equivalent.

In a case where there is no mass in which the variable state is not equivalent in the verification table, the correction candidate generation unit 116 determines that it is equivalent, and ends the processing (P162). When at least one variable state is not equivalent, a mass in which the variable state is not equivalent is a target (P163). In this example, in the verification table 1800 of FIG. 18, the variable state is not equivalent in a mass 1804 corresponding to the original snapshot S109 and the modified snapshot S322, and thus, the mass 1804 is a target.

In the case of a target mass in which the path restriction is equivalent, the correction candidate generation unit 116 proceeds to Step P165, and in the case of a target mass in which the path restriction is not equivalent, the correction candidate generation unit 116 proceeds to Step P166 (P163).

In a case where the path restriction of the original snapshot is equivalent to the path restriction of the modified snapshot, snapshots are generated through an equivalent condition branch, but the variable states are different from each other, and thus, a non-equivalent situation is obtained. In a case where the variable state of the modified snapshot is substituted with the variable state of the original snapshot, the variable state is equivalent in the target mass, and thus, the correction candidate generation unit 116 stores the operation of substituting the variable state of the modified snapshot of the target mass with the variable state of the original snapshot in the correction candidate storage region 206 as the correction candidate (P165), and proceeds to Step P161.

The correction candidate generation unit 116 performs scanning in a vertical direction of the target mass in the verification table 1800, searches the other mass in which the path restriction is not equivalent, and in a case where there is the other mass in which the path restriction is not equivalent, proceeds to Step P167. In a case where there is no other mass, the correction candidate generation unit 116 proceeds to Step P168 (P166).

In a case where there is the other mass in which the path restriction is not equivalent, in the target mass, the path restriction is not equivalent, and the variable state is not equivalent, and a state where there is the other mass in the vertical direction in which the path restriction is not equivalent is obtained from the target mass. The other mass in which the path restriction is not equivalent being in the vertical direction represents that the path restriction of the modified snapshot of the target mass includes a portion overlapping with the path restriction of the original snapshot of the mass in the vertical direction in which the path restriction is not equivalent. Accordingly, the correction candidate generation unit 116 stores an operation of resolving the modified snapshot of the target mass by using the path restriction of the original snapshot of the target mass in the correction candidate storage region 206 as the correction candidate (P167), and proceeds to Step P161.

In this example, in FIG. 18, the correction candidate generation unit 116 sets the mass 1804 as a target, and a mass 1803 is the other mass in the vertical direction in which the path restriction is not equivalent, and thus, in Step P166, the mass 1803 is detected, and the correction candidate generation unit 116 proceeds to Step P167. The correction candidate generation unit 116 sets the path restriction of ¬ (γ=1) ∧ ¬ (α>1) of the original snapshot S113 in the mass 1803 to a resolution standard, and the path restriction of ¬ (γ=1) of the modified snapshot S322 in the mass 1804 to a resolution target, and performs the resolution (P167). Each of the resolution standard and the resolution target is the path restriction, and thus, is in a shape where a plurality of restriction items are joined together by the conjunction. At the time of the resolution, a restriction item which is common in the resolution standard and the resolution target is eliminated from the resolution standard. Here, in this example, the common restriction item is ¬ (γ=1), and thus, the resolution standard is ¬ (α>1). The resolution standard is added to the resolution target with affirmation or disaffirmation, and thus, the mass 1803 is resolved.

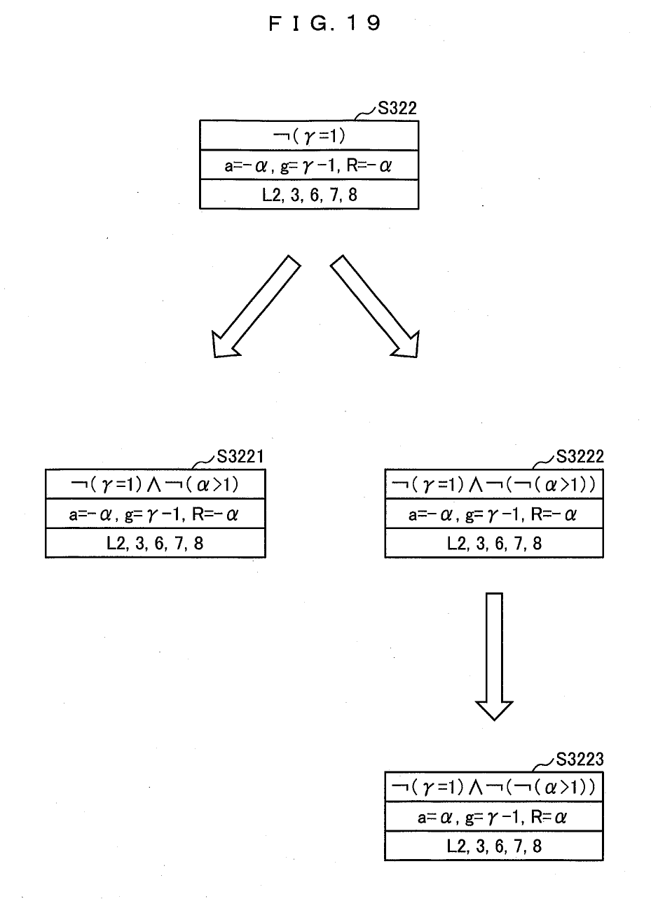

FIG. 19 is an example of a snapshot resolution operation and a variable state modification operation, and is a result obtained by resolving the modified snapshot S322 to a snapshot S3221 and a snapshot S3222. ¬ (α>1) which is the affirmation of the resolution standard is added to a path restriction of the snapshot S3221, and ¬ (¬ (α>1)) which is the disaffirmation of the resolution standard is added to a path restriction of the other snapshot S3222. The variable states of both of the snapshots are identical to those before the resolution. The correction candidate generation unit 116 stores the resolution operation in the correction candidate storage region 206.

The correction candidate generation unit 116 performs scanning in a horizontal direction of the target mass in the verification table 1800, searches the other mass in which the path restriction is not equivalent, and in a case where there is the other mass in which the path restriction is not equivalent, proceeds to Step P169 (P168). In a case where there is no other mass, the correction candidate generation unit 116 ends the processing by setting that there is no correction candidate.

In a case where the is no other mass in which the path restriction is not equivalent, the path restriction of the target mass is not equivalent, and the variable state of the target mass is not equivalent, and thus, a state where there is the mass in the horizontal direction in which the path restriction is not equivalent is obtained from the target mass. The mass in which path restriction is not equivalent being in the horizontal direction represents that the path restriction of the original snapshot of the target mass includes a portion overlapping with the path restriction of the modified snapshot of the other mass in the horizontal direction in which the path restriction is not equivalent. Accordingly, the correction candidate generation unit 116 stores an operation of integrating the modified snapshot of the target mass and the modified snapshot of the other mass in the horizontal direction in which the path restriction is not equivalent in the correction candidate storage region 206 as the correction candidate (P169), and proceeds to Step P161. In the integration operation, the path restrictions of both of the snapshots are coupled by the disjunction, and an arbitrary variable state is adopted in the variable state.

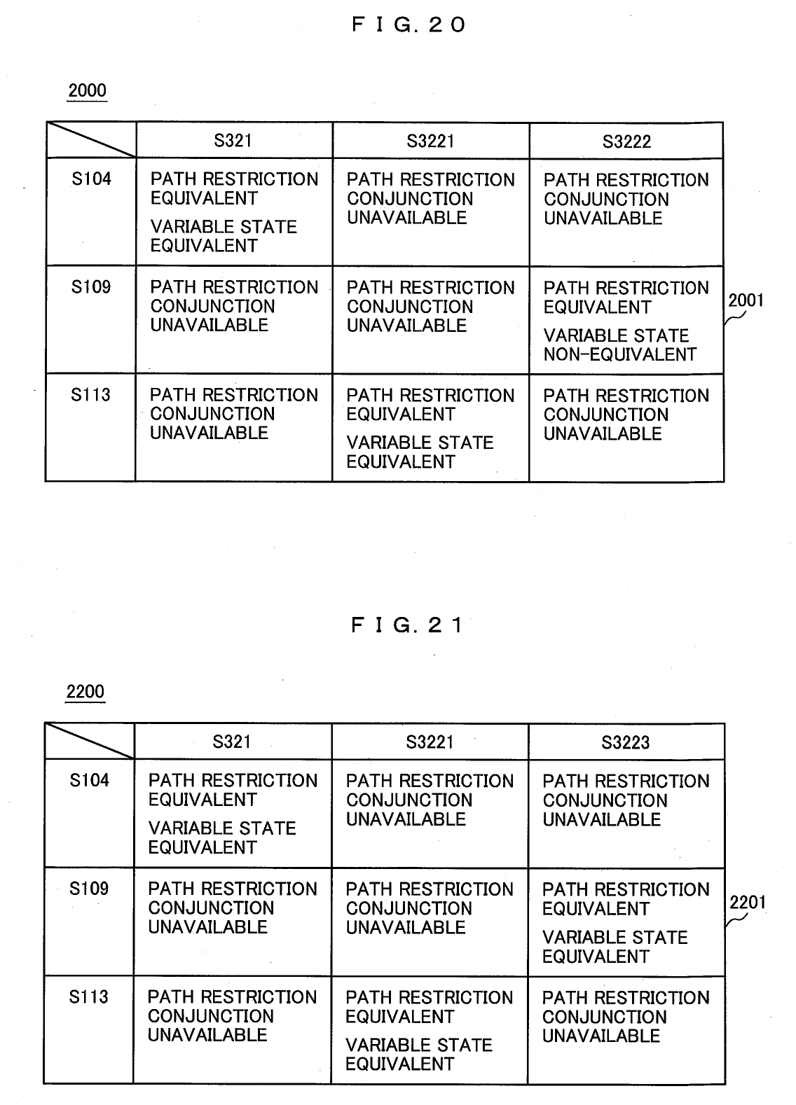

The correction candidate generation unit 116 reconstructs the verification table 1800 by using the variable state modification operation, the path restriction resolution operation, or the path restriction integration operation, which is stored in the correction candidate storage region 206 (P161). In this example, the modified snapshot S322 is subjected to the resolution operation to be the snapshot S3221 and the snapshot S3222, and the correction candidate generation unit 116 divides a column 1805 of FIG. 18, prepares a verification table 2000 illustrated in FIG. 20, determines again the satisfiability with respect to the path restriction conjunction expression, the path restriction equivalent determination expression, and the path equivalence verification expression of each of the masses by using the resolved snapshot, and updates the verification table. The correction candidate generation unit 116 reconstructs the verification table, and then, returns to Step P162, and repeats the same processing.

In this example, in the verification table 2000 of FIG. 20, a mass 2001 which is a combination between the original snapshot S109 and the modified snapshot S3222 is a target in Step P163, and the path restriction of the target mass is equivalent, and thus, the correction candidate generation unit 116 proceeds to Step P165, and stores an operation of substituting the variable state of the modified snapshot S3222 with the variable state of the original snapshot S109 in the correction candidate storage region 206. The corrected snapshot to which the operation of substituting the variable state of the modified snapshot S3222 with the variable state of the original snapshot S109 is applied, is a snapshot S3223 of FIG. 19, and the correction candidate generation unit 116 proceeds to Step P161. In Step P161, the correction candidate generation unit 116 substitutes the snapshot S3222 of FIG. 20 with the snapshot S3223 of FIG. 19, and constructs the verification table 2200 as illustrated in FIG. 21. In the verification table 2200, the mass 2001 in the verification table 2000 in which the variable state is not equivalent is corrected as with the mass 2201. According to the operation described above, there is no mass in the verification table 2200 in which the variable state is not equivalent, and thus, in Step P162, the correction candidate generation is ended. When the correction candidate generation is ended, the operation stored in the correction candidate storage region 206 is applied to the modified source code, and thus, the modified source code is logically equivalent to the original source code.

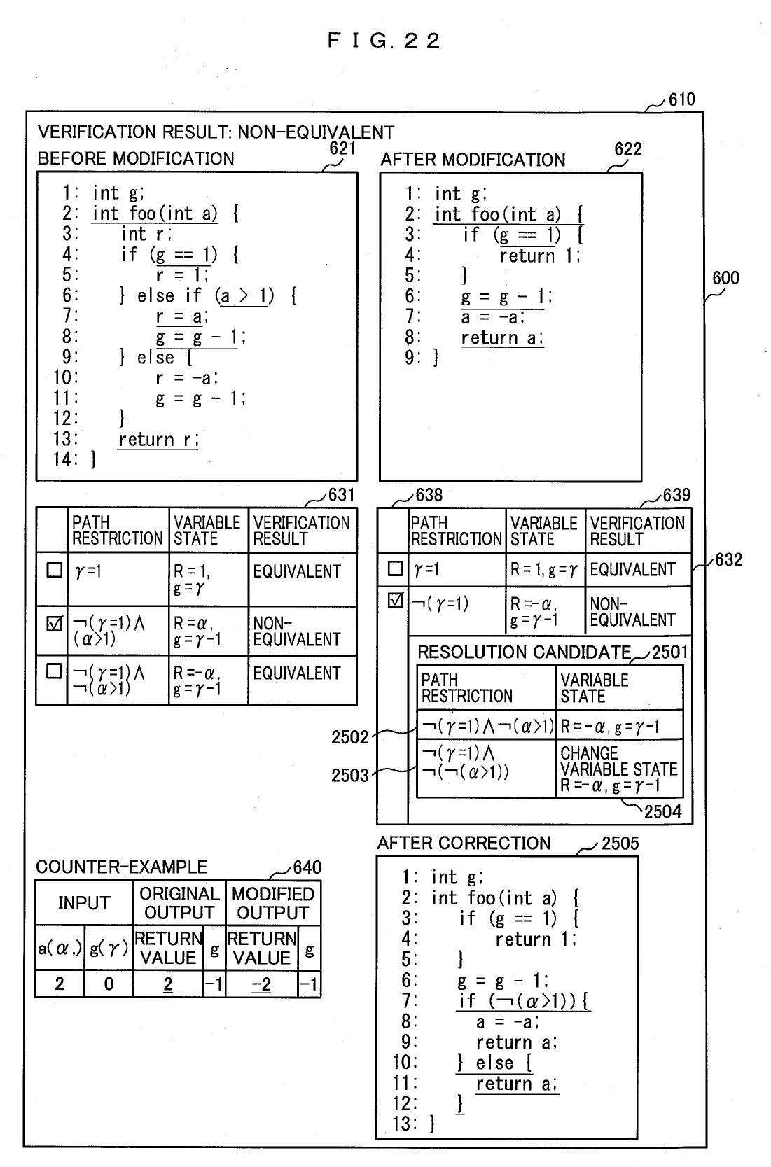

FIG. 22 is an example of a verification result report 600 generated by the verification result generation unit 117. The verification result report 600 displays “equivalent” in a case where all path equivalence verification expression verification results are not capable of being satisfied, and displays “not equivalent” in a case where there is a path equivalence verification expression which is capable of being satisfied, as a verification result display 610. In this example, for example, the path equivalence verification expression at the time of selecting snapshot S109 and the snapshot S322 is capable of being satisfied, and thus, “not equivalent” is displayed.

The verification result report 600 may include displays of an original symbolic execution summary 631 and a modified symbolic execution summary 632 by using the symbolic execution summary information stored in the symbolic execution result storage regions 203 before and after modification. At this time, a verification result 639 of the snapshot can be displayed on the display of the modified symbolic execution summary 632.

In the verification result 639 of the snapshot, “equivalent” is displayed in a case where all of the verification results of the path equivalence verification expressions selecting the snapshot are not capable of being satisfied, and “not equivalent” is displayed in a case where there is a path equivalence verification expression which is capable of being satisfied, with reference to the verification result 1602 of each of the path equivalence verification expressions illustrated in FIG. 16. In this example, all of the path equivalence verification expressions selecting the snapshot S104, all of the path equivalence verification expressions selecting the snapshot S113, and all of the path equivalence verification expressions selecting the snapshot S321 are not capable of being satisfied, and thus, the corresponding verification result is displayed as “equivalent”. On the other hand, in the other snapshots, there is a path equivalence verification expression which is capable of being satisfied, and thus, the corresponding verification result is displayed as “not equivalent”.

The verification result report may include a display of counter-example information 640 not to be equivalent by using counter-example information stored in the equivalence verification expression verification result storage region 205. At this time, a check box 638 for selecting the snapshot during the display of the symbolic execution summary may be provided, and thus, a counter-example of the path equivalence verification expression with respect to the combination of the selected snapshots may be displayed.

In the example illustrated in FIG. 22, when the check boxes corresponding to the snapshot S103 and the snapshot S322 are selected, information obtained from a counter-example 1601 of the path equivalence verification expression generated from the snapshot S109 and the snapshot S322 in FIG. 16 is displayed.

The verification result report 600 may further include displays of an original source code 621 and a modified source code 622 by using the source code information stored in the source code storage regions 201 before and after modification. At this time, the route of the snapshot on the source code may be displayed from positional information of the snapshot with respect to the snapshot selected by using the check box 638 for selecting the snapshot.

In the example illustrated in FIG. 22, the route of the snapshot S109 is displayed in an underline on the original source code 621 by using the positional information of snapshot S109. In addition, the route of the snapshot S322 is displayed in an underline on the modified source code 622 by using the positional information of the snapshot S322.

The route is displayed in a different aspect from the other portion, such as displaying the background in a different color, performing highlighting by changing a character style or a character size, and displaying only the route by deleting the display of a portion other than the route, as a method of displaying the route, other than the method displayed in the underline, illustrated in FIG. 22.

In a case where the equivalence verification result with respect to a combination of certain snapshots is not equivalent, and a cause of not being equivalent is investigated, the cause is on the route of the snapshot, and the portion other than the route does not affect the result of the snapshot, and thus, is not required to be investigated.

The route corresponding to the selected snapshot is displayed on the source code, and a counter-example corresponding to the combination thereof is displayed, and thus, the range in which the developer necessarily performs investigation on the source code can be narrowed with respect to an input and an output not to be equivalent, and the cause of non-equivalence can be easily found.

The verification result report 600 may include a display of a correction candidate 2501 for being equivalent with respect to a correction target portion of the modified symbolic execution summary 632 by using the correction candidate information stored in the correction candidate storage region 206.

In the example illustrated in FIG. 22, in the modified snapshot S322, the resolution operation with respect to the snapshots S3221 and S3222 illustrated in FIG. 19 is stored in the correction candidate storage region 206 as the correction candidate, and thus, a resolved snapshot 2502 corresponding to the snapshot S3221 and a resolved snapshot 2503 corresponding to the snapshot S3222 are displayed. In addition, an operation of correcting the variable state from the snapshot S3222 to the snapshot S3223 is stored in the correction candidate storage region 206 as the correction candidate, and thus, display on which the substitution of the variable state is reflected is performed on a variable state 2504 of the resolved snapshot 2503, as an operation after the resolution.

Examples of the method of displaying the correction candidate include a method such as displaying the correction candidate on the route corresponding to the selected snapshot of the modified source code, in addition to the method of displaying the correction candidate on the modified symbolic execution summary illustrated in FIG. 22.

The correction candidate representing a correction method of the path restriction and the variable state of the modified snapshot in order to allow the combination of the snapshots, which are not equivalent, to be equivalent, is displayed, and thus, the portion to be corrected on the source code by the developer or the correction method can be narrowed with respect to the input and the output not to be equivalent, and the non-equivalence is easily corrected.

The verification result report 600 may apply the correction candidate to the modified source code 622 by using the source code information stored in the source code storage regions 201 before and after modification and the correction candidate information stored in the correction candidate storage region 206, and may include a display of a corrected source code 2505 which is corrected to be logically equivalent to the original source code.

In the example illustrated in FIG. 22, the correction candidate information stored in the correction candidate storage region 206, first, is the resolution of the modified snapshot S322 in which the resolution standard is set to ¬ (α>1). According to such a resolution standard, a branch of an if statement is added to the seventh row of the corrected source code 2505 on the route passed by the modified snapshot S322, and a branch of an else statement representing the route of the disaffirmation of the resolution standard is added to the tenth row. In the resolved snapshot S3221, that is, the resolved snapshot 2502 of FIG. 22, there is no modification in the variable state, and thus, the eighth row and the ninth row remain the same. The resolved snapshot S3222 is the snapshot S3223 by being subjected to the variable state modification operation, and thus, the eleventh row of the corrected source code 2505 is a source code realizing the modified variable state.

At this time, a portion corrected by the path restriction resolution operation or the variable state modification operation is displayed in an underline. The corrected portion is displayed in a different aspect from the other portion, such as displaying the background in a different color, performing highlighting by changing a character style or a character size, and displaying only the route by deleting the display of a portion other than the corrected portion, a method of displaying the corrected portion, other than the method displayed in the underline, illustrated in FIG. 22.

The corrected source code is a source code to which the correction allowing the modified source code to be logically equivalent to the original source code is mechanically applied, and thus, there is a possibility that readability or maintainability is low, and a possibility that it is difficult to use the corrected source code as it is. However, in the original source code and the modified source code, which are not equivalent to each other, the correction method of the modified source code to allow the modified source code to be equivalent to the original source code is represented, and thus, the correction method on the source code performed by the developer is easily considered.

### REFERENCE SIGNS LIST

1000 source code equivalence verification device

101 CPU

102 main storage device

103 network I/F

104 graphic I/F

105 input and output I/F

106 auxiliary storage device I/F

110 control unit

120 display and output device

121 output device

130 input device

131 keyboard

132 mouse

140 storage unit

141 HDD

142 DVD drive

150 external network

160 external computer

200 source code equivalence verification program

201 source code storage regions before and after modification

202 structural graph storage regions before and after modification

203 symbolic execution result storage regions before and after modification

204 equivalence verification expression storage region

205 equivalence verification expression verification result storage region

206 correction candidate storage region

207 verification result storage region

111 source code input unit

112 structural graph generation unit

113 symbolic execution calculation unit

114 equivalence verification expression generation unit

115 equivalence verification expression verification unit

116 correction candidate generation unit

117 verification result generation unit

C100, C200, C300 source code

S100, S200, S300 execution tree of symbolic execution

S120, S220, S320 symbolic execution summary

S104, S109, S113, S221 to S223, S321 to S323 snapshot in symbolic execution

S101a path restriction of node of symbolic execution tree

S101b variable state of node of symbolic execution tree

S101c positional information of node of symbolic execution tree

N100 structural graph

1800, 2000, 2200 verification table

500, 600 verification result report

1. A source code equivalence verification device, comprising:
a symbolic execution calculation unit performing symbolic execution with respect to each of an original source code and a modified source code;
an equivalence verification expression generation unit generating an equivalence verification expression of the original source code and the modified source code by using a symbolic execution result of the symbolic execution calculation unit;
an equivalence verification expression verification unit verifying the equivalence verification expression generated by the equivalence verification expression generation unit;
a correction candidate generation unit generating a correction candidate for allowing the original source code to be equivalent to the modified source code in a case where the original source code is not equivalent to the modified source code as a verification result of the equivalence verification expression of the equivalence verification expression verification unit; and
a verification result generation unit generating a verification result report by using the verification result of the equivalence verification expression verification unit and the correction candidate of the correction candidate generation unit.

2. The source code equivalence verification device according to claim 1,
wherein the equivalence verification expression generation unit generates a path restriction conjunction expression, a path restriction equivalent determination expression, and a path equivalence verification expression with respect to a combination of each snapshot configuring a symbolic execution summary of the original source code and the modified source code, as the equivalence verification expression.

3. The source code equivalence verification device according to claim 2,
wherein the equivalence verification expression verification unit verifies the path restriction conjunction expression, the path restriction equivalent determination expression, and the path equivalence verification expression.

4. The source code equivalence verification device according to claim 3,
wherein in a case where the original source code is not equivalent to the modified source code as a verification result of the equivalence verification expression verification unit, the correction candidate generation unit generates at least one operation of a variable state modification operation, a path restriction resolution operation, and a path restriction integration operation, in which the correction candidate for allowing the modified source code to be equivalent to the original source code is obtained.

5. The source code equivalence verification device according to claim 4,
wherein in a case where the verification result of the equivalence verification expression verification unit is not equivalent, the verification result generation unit includes a display of the operation in the verification result report generated by the correction candidate generation unit.

6. The source code equivalence verification device according to claim 4,
wherein in a case where the verification result of the equivalence verification expression verification unit is not equivalent, the verification result generation unit applies the operation generated by the correction candidate generation unit to the modified source code, and includes the modified source code which is corrected to be equivalent to the original source code in the verification result report.

7. A source code equivalence verification method of a source code equivalence verification device,
wherein the source code equivalence verification device,
performs symbolic execution with respect to each of an original source code and a modified source code;
generates an equivalence verification expression of the original source code and the modified source code by using a symbolic execution result;
verifies the equivalence verification expression;
generates a correction candidate for allowing the original source code to be equivalent to the modified source code in a case where the original source code is not equivalent to the modified source code as a verification result of the equivalence verification expression; and
generates a verification result report by using the verification result of the equivalence verification expression and the correction candidate.

8. The source code equivalence verification method according to claim 7,
wherein the source code equivalence verification device, generates a path restriction conjunction expression, a path restriction equivalent determination expression, and a path equivalence verification expression with respect to a combination of each snapshot configuring a symbolic execution summary of the original source code and the modified source code, as the equivalence verification expression.

9. The source code equivalence verification method according to claim 8,
wherein the source code equivalence verification device,
verifies the path restriction conjunction expression, the path restriction equivalent determination expression, and the path equivalence verification expression.

10. The source code equivalence verification method according to claim 9,
wherein the source code equivalence verification device,
generates at least one operation of a variable state modification operation, a path restriction resolution operation, and a path restriction integration operation, in which the correction candidate for allowing the modified source code to be equivalent to the original source code is obtained, in a case where the original source code is not equivalent to the modified source code as the verification result.

11. The source code equivalence verification method according to claim 10,
wherein the source code equivalence verification device,
includes a display of the operation in the verification result report in a case where the verification result is not equivalent.

12. The source code equivalence verification method according to claim 10,
wherein the source code equivalence verification device,
applies the operation to the modified source code, and includes the modified source code which is corrected to be equivalent to the original source code in the verification result report in a case where the verification result is not equivalent.
